(19) United States
(12) Patent Application Publication
(10) Pub. No.: US 2024/0343196 A1
(43) Pub. Date: Oct. 17, 2024

(54) Semi-Trailer Truck With Visual Assistance System

(71) Applicant: Mary McCoy, Shreveport, LA (US)

(72) Inventor: Mary McCoy, Shreveport, LA (US)

(21) Appl. No.: 18/133,674

(22) Filed: Apr. 12, 2023

(51) Int. Cl. B60R 1/27; B60Q 1/22; B60Q 1/24; B60Q 9/00

(52) U.S. Cl. CPC B60R 1/27; B60Q 1/22; B60Q 1/24; B60Q 9/008; B60R 2300/105; B60R 2300/20; B60R 2300/8093

(57) ABSTRACT

A semi-trailer truck with visual assistance system for a semi-trailer truck includes a semi-trailer truck including a truck cab and a semi-trailer removably attaches to the truck cab. A driving assistance assembly attaches to the semi-trailer truck and facilitates reverse driving a semi-trailer truck by providing visuals of an exterior of the semi-trailer truck to the driver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trailer driving assistance systems and more particularly pertains to a new trailer driving assistance system for a semi-trailer truck.

### (2) Description of Related Art Including Information Disclosed Under 37 CFR 1.97 and 1.98

The prior art relates to trailer driving assistance systems and includes a variety of trailer driving assistance systems used by a semi-trailer truck. Known prior art does not allow a trailer driving assistance system to facilitate reverse driving of a semi-trailer truck with visuals of an exterior of a semi-trailer.

### BRIEF SUMMARY OF THE INVENTION

An embodiment of the disclosure meets the needs presented above by generally comprising a semi-trailer truck including a truck cab. A semi-trailer removably attaches to the truck cab. A driving assistance assembly attaches to the semi-trailer truck and is configured for facilitating reverse driving a semi-trailer truck by providing visuals of an exterior of the semi-trailer truck to the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a semi-trailer truck with visual assistance system according to an embodiment of the disclosure.

FIG. 2 is a rear view of an embodiment of the disclosure.

FIG. 3 is a detail view of an embodiment of the disclosure.

FIG. 4 is a block diagram view of an embodiment of the disclosure.

### DETAILED DESCRIPTION OF THE INVENTION

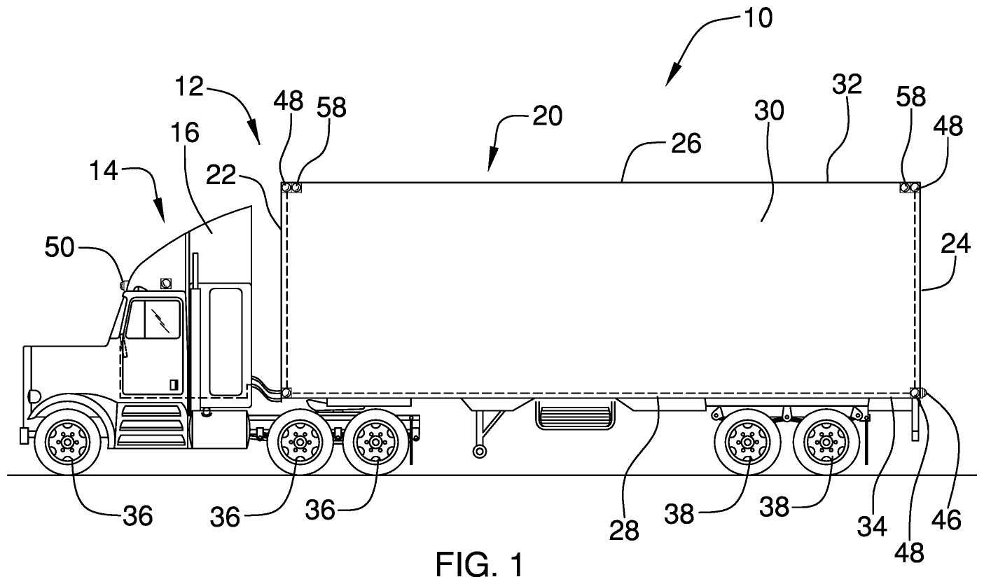

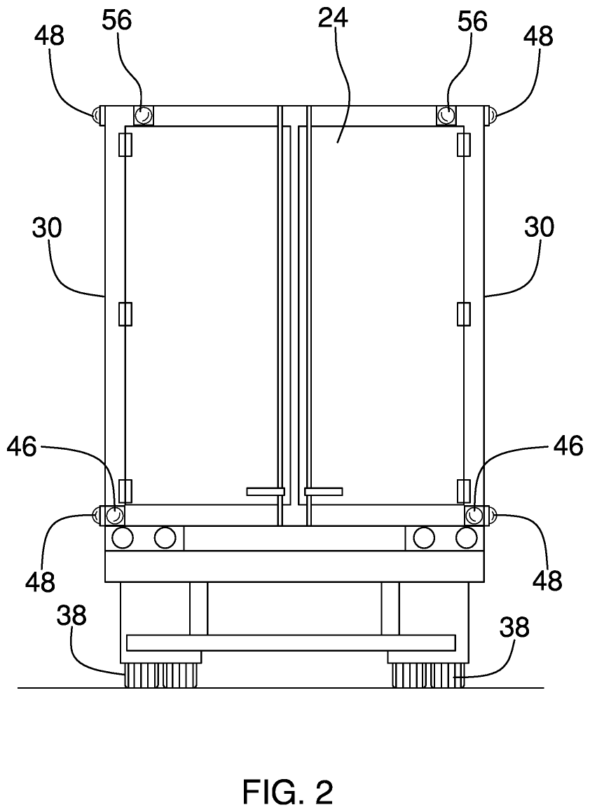

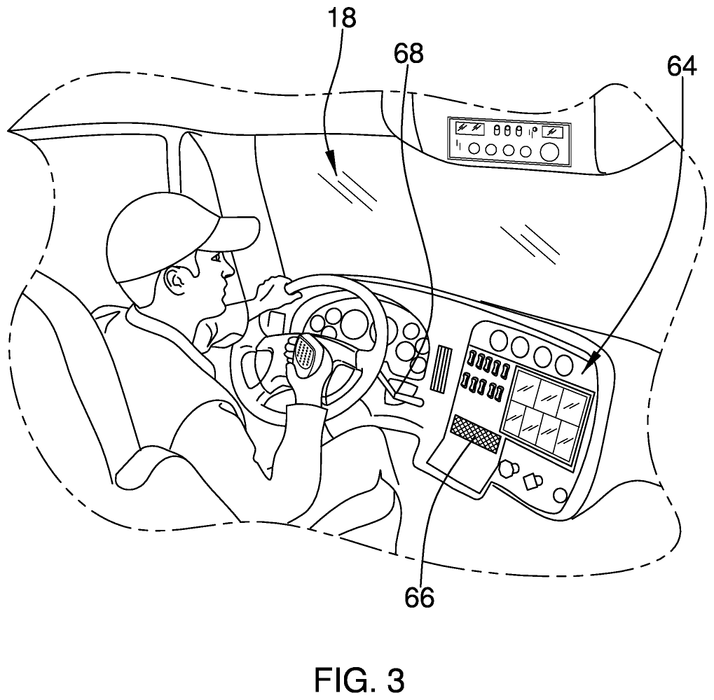

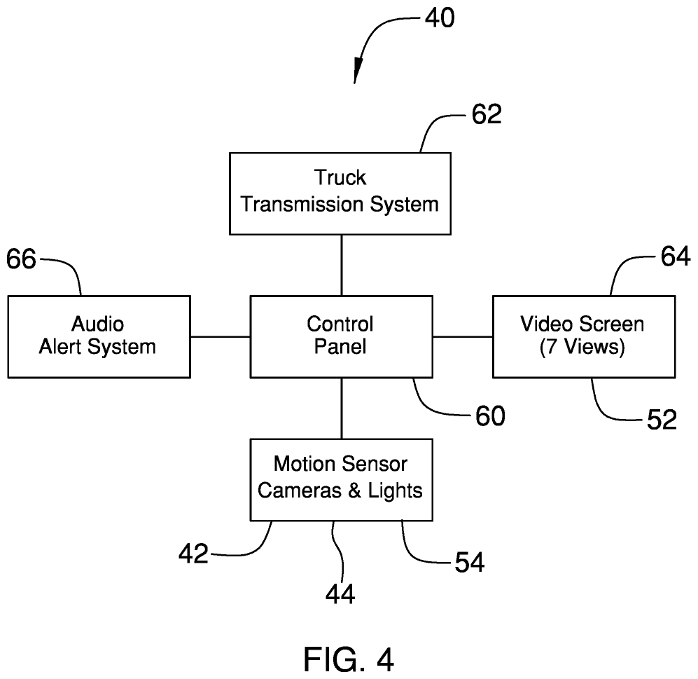

With reference now to the drawings, and in particular to FIGS. 1 through 4 thereof, a new trailer driving assistance system embodying the principles and concepts of an embodiment of the disclosure and generally designated by the reference numeral 10 will be described.

As best illustrated in FIGS. 1 through 4, the semi-trailer truck with visual assistance system 10 generally comprises a semi-trailer truck 12 including a truck cab 14. The truck cab 14 includes an exterior frame 16 enclosing an interior space 18 wherein the exterior frame 16 is configured for a driver to be positioned within the interior space 18. A semi-trailer 20 removably attaches to the truck cab 14 and typically comprises a rectangular prism having a front wall 22, a back wall 24, a top wall 26, a bottom wall 28, and a pair of side walls 30. The semi-trailer 20 has a top perimeter edge 32 and a bottom perimeter edge 34. A plurality of cab wheels 36 rotably couples to the truck cab 14 and is configured for mobilizing the semi-trailer truck 12. A plurality of trailer wheels 38 rotably couples to semi-trailer 20 and the trailer wheels 38 are positioned on the bottom wall 28 of the semi-trailer 20.

A driving assistance assembly 40 attaches to the semi-trailer truck 12 and is configured for facilitating reverse driving the semi-trailer truck 12 by providing visuals of an exterior of the semi-trailer truck 12 to the driver. The driving assistance assembly 40 includes a plurality of cameras 42 having motion sensors 44 and records visuals of the exterior of the semi-trailer truck 12. The cameras 42 normally include a plurality of back cameras 46, a plurality of side cameras 48, and a plurality of front cameras 50. The back cameras 46 are attached to the back wall 24 of the semi-trailer 20 and are positioned adjacent to the bottom perimeter edge 34 of the semi-trailer 20. The side cameras 48 are attached to the side walls 30 of the semi-trailer 20 and are positioned adjacent to the top 32 and bottom 34 perimeter edges of the semi-trailer 20. The front cameras 50 are attached to the exterior frame 16 of the truck cab 14. The cameras 42 are configured for recording a plurality of views 52 of the semi-trailer truck 12 including a front view, a back view, a first side view, a second side view, an angle view, a top view, and a bottom view.

A plurality of lights 54 electrically couples to the cameras 42 and emits light when actuated by the driving assistance assembly 40. The lights 54 normally include a plurality of back lights 56 and a plurality of side lights 58. The back lights 56 are attached to the back wall 24 and the side lights 58 are attached to the side walls 30. The lights 54 are positioned adjacent to the top perimeter wall 32 of the semi-trailer 20 to provide overhead lighting to back 24 and side 30 walls of the semi-trailer 20.

A control panel 60 is electrically coupled to the cameras 42 and the lights 54. The control panel 60 is configured for electrically coupling to a transmission system 62 of the semi-trailer truck 12. The control panel 60 is configured for being programmed to provide supplementary driving assistance such as determination of steering angle or obstacle avoidance assistance. A monitor 64 is electrically coupled to the control panel 60 and displays recorded visuals from the cameras 42. The monitor 64 will typically be positioned within the interior space 18 of the truck cab 14 with the driver. A speaker 66 is electrically coupled to the control panel 60 and emits an audible alarm when the motion sensors 44 of the cameras 42 detect the semi-trailer truck 12 is positioned proximate to an obstacle.

In use, the driving assistance assembly 40 is actuated when a transmission lever 68 of the transmission system 62 of semi-trailer truck 12 is positioned into a reverse position. The monitor 64 displays recorded visuals from the cameras 42 and the motion sensors 44 detect when the semi-trailer truck 12 is proximate to obstacles such as other vehicles and alerts the driver by emitting the audible alarm from the speaker 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A semi-trailer truck with driving assistance system comprising:
a semi-trailer truck including:
a truck cab;
a semi-trailer removably attaching to said truck cab; and
a driving assistance assembly attaching to said semi-trailer truck and being configured for facilitating reverse driving a semi-trailer truck by providing visuals of an exterior of the semi-trailer truck to the driver.

2. The semi-trailer truck with driving assistance system of claim 1, wherein said truck cab includes an exterior frame, said exterior frame encloses an interior space wherein the exterior frame is configured for a driver to be positioned within the interior space.

3. The semi-trailer truck with driving assistance system of claim 2, wherein said semi-trailer comprises a rectangular prism having a front wall, a back wall, a top wall, a bottom wall, and a pair of side walls, said semi-trailer having a top perimeter edge and a bottom perimeter edge.

4. The semi-trailer truck with driving assistance system of claim 2, further including a plurality of cab wheels rotatably coupling to said truck cab and being configured for mobilizing said semi-trailer truck.

5. The semi-trailer truck with driving assistance system of claim 3, further including a plurality of trailer wheels rotatably coupling to semi-trailer, said trailer wheels being positioned on said bottom wall of said semi-trailer.

6. The semi-trailer truck with driving assistance system of claim 1, wherein said driving assistance assembly includes a plurality of cameras having motion sensors and recording visuals of the exterior of the semi-trailer truck.

7. The semi-trailer truck with driving assistance system of claim 3, wherein said cameras includes a plurality of back cameras, a plurality of side cameras, and a plurality of front cameras, said back cameras being attached to said back wall of said semi-trailer, said back cameras being positioned adjacent to said bottom perimeter edge of said semi-trailer, said side cameras being attached to said side walls of said semi-trailers, said side cameras being positioned adjacent to said top and bottom perimeter edges of said semi-trailer, said front cameras being attached to said exterior frame of said truck cab.

8. The semi-trailer truck with driving assistance system of claim 7, further including a plurality of lights electrically coupling to said cameras and emitting light when actuated by said driving assistance assembly, said lights including a plurality of back lights and a plurality of side lights, said back lights being attached to said back wall and said side lights being attached to said side walls, said lights being positioned adjacent to said top perimeter wall of said semi-trailer.

9. The semi-trailer truck with driving assistance system of claim 8, further including a control panel being electrically coupled to said cameras and said lights, said control panel being configured for electrically coupling to a transmission system of said semi-trailer truck.

10. The semi-trailer truck with driving assistance system of claim 9, further including a monitor being electrically coupled to said control panel and displaying recorded visuals from said cameras, said monitor being positioned within said interior space of said truck cab.

11. The semi-trailer truck with driving assistance system of claim 10, further including a speaker being electrically coupled to said control panel and emitting and audible alarm when said motion sensors of said cameras detect said semi-trailer truck being positioned proximate to an obstacle.

12. A semi-trailer truck with driving assistance system comprising:
a semi-trailer truck including:
a truck cab, said truck cab including an exterior frame, said exterior frame encloses an interior space wherein the exterior frame is configured for a driver to be positioned within the interior space;
a semi-trailer removably attaching to said truck cab, said semi-trailer comprising a rectangular prism having a front wall, a back wall, a top wall, a bottom wall, and a pair of side walls, said semi-trailer having a top perimeter edge and a bottom perimeter edge;
a plurality of cab wheels rotatably coupling to said truck cab and being configured for mobilizing said semi-trailer truck; and
a plurality of trailer wheels rotably coupling to semi-trailer, said trailer wheels being positioned on said bottom wall of said semi-trailer; and
a driving assistance assembly attaching to said semi-trailer truck and being configured for facilitating reverse driving a semi-trailer truck by providing visuals of an exterior of the semi-trailer truck to the driver, said driving assistance assembly including:
a plurality of cameras having motion sensors and recording visuals of the exterior of the semi-trailer truck, said cameras including a plurality of back cameras, a plurality of side cameras, and a plurality of front cameras, said back cameras being attached to said back wall of said semi-trailer, said back cameras being positioned adjacent to said bottom perimeter edge of said semi-trailer, said side cameras being attached to said side walls of said semi-trailers, said side cameras being positioned adjacent to said top and bottom perimeter edges of said semi-trailer, said front cameras being attached to said exterior frame of said truck cab;
a plurality of lights electrically coupling to said cameras and emitting light when actuated by said driving assistance assembly, said lights including a plurality of back lights and a plurality of side lights, said back lights being attached to said back wall and said side lights being attached to said side walls, said lights being positioned adjacent to said top perimeter wall of said semi-trailer;
a control panel being electrically coupled to said cameras and said lights, said control panel being configured for electrically coupling to a transmission system of said semi-trailer truck;
a monitor being electrically coupled to said control panel and displaying recorded visuals from said cameras, said monitor being positioned within said interior space of said truck cab; and
a speaker being electrically coupled to said control panel and emitting an audible alarm when said motion sensors of said cameras detect said semi-trailer truck being positioned proximate to an obstacle.
